(19) United States
(12) Patent Application Publication
(10) Pub. No.: US 2020/0001868 A1
(43) Pub. Date: Jan. 2, 2020

(54) METHOD AND APPARATUS FOR UPDATING APPLICATION BASED ON DATA IN AN AUTONOMOUS DRIVING SYSTEM

(71) Applicant: LG Electronics Inc., Seoul (KR)

(72) Inventor: Hansung LEE, Seoul (KR)

(21) Appl. No.: 16/558,034

(22) Filed: Aug. 30, 2019

(30) Foreign Application Priority Data
Aug. 5, 2019 (KR) 10-2019-0095185

(51) Int. Cl. B60W 30/095; G05D 1/00; G06F 8/65; G07C 5/00

(52) U.S. Cl. CPC B60W 30/0953; G05D 1/0088; B60W 2050/0077; G07C 5/008; G06F 8/65

(57) ABSTRACT

A method for updating an application for autonomous driving of a vehicle in an automated vehicle and highway systems. The method includes acquiring i) sensor data, ii) processing data, iii) database-based data, and/or iv) external data associated with an event; generating a simulation model for the event based on the data, tracking an object associated with the event based on the simulation model; updating an application for the autonomous driving based on tracking the object; and transmitting the information on the updated application to the vehicle. The application for autonomous driving of the vehicle may be updated to help prevent occurrence of the event. At least one of an autonomous vehicle, a user terminal and a server may be associated with an artificial intelligence module, a drone (Unmanned Aerial Vehicle, UAV) robot, augmented reality (AR) device, virtual reality (VR) device, a device related to a 5G service, and the like.

### CROSS-REFERENCE TO RELATED APPLICATIONS

This application claims the benefit of KR Application No. 10-2019-0095185 filed on Aug. 5, 2019. The contents of this application are hereby incorporated by reference in its entirety.

### BACKGROUND OF THE INVENTION

### Field of the invention

The present invention relates to an autonomous driving system, and more particularly, to a method and apparatus for updating an application based on data acquired in connection with occurrence of a specific event.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

An object of the present invention is to propose a method and device for updating an application, an algorithm, and/or software based on data acquired by a vehicle in connection with occurrence of a specific event in an autonomous driving system.

Also, another object of the present invention is to propose a method and device for updating an application, an algorithm, and/or software by tracking at least one object in connection with a specific event in an autonomous driving system.

It will be appreciated by persons skilled in the art that the objects that could be achieved with the present invention are not limited to what have been particularly described hereinabove and the above and other objects that the present invention could achieve will be more clearly understood from the following detailed description.

An aspect of the present invention, in method for updating an application for autonomous driving of a vehicle in an automated vehicle and highway systems, the method may comprises the steps of acquiring at least one of i) sensor data, ii) processing data, iii) database (DB)-based data, or iv) external data associated with a specific event; generating a simulation model for the occurrence of the specific event based on the acquired data, tracking at least one object associated with the specific event based on the simulation model; updating an application for the autonomous driving based on a tracking result of the at least one object, and transmitting the information on the updated application to the vehicle.

Further, in the method, the specific event may be a collision event between the vehicle and another object.

Further, in the method, the processing data may be acquired by performing a processing operation for the autonomous driving on the sensor data, and the DB-based data may include at least one of geographic information, traffic information, or autonomous driving infrastructure information determined based on location information of the vehicle.

Further, in the method, the external data may include information on a surrounding environment or information on the at least one object when the collision event occurs.

Further, in the method, the simulation model may be generated based on the occurrence of the collision event designed based on the acquired data and/or a control operation of the vehicle to reproduce the occurrence of the collision event.

Further, in the method, the simulation model may operate based on an application installed in the vehicle when the collision event occurs.

Further, in the method, the step of tracking the at least one object associated with the specific event may comprise the step of tracking objects in the order of high relevance, in consideration of relevance to the specific event.

Further, in the method, a first object that collided with the vehicle may be assigned in a high priority of the relevance, and a second object associated only with the first object may be assigned in a low priority of the relevance.

Further, the method may further comprise the step of tracking the objects in the order of high relevance, thereby identifying information of the object that causes the collision event.

Further, the method may further comprise the step of monitoring one or more objects determined using the information of the object that causes the collision event based on the updated application.

Further, the method may further comprise the step of receiving information on a scheduled route of the vehicle from the vehicle; and reconfiguring the updated application based on the information on the scheduled route of the vehicle.

Further, in the method, the information on the scheduled route of the vehicle may include at least one of i) traffic pattern information associated with the scheduled route, ii) weather information associated with the scheduled route, or iii) collision event information associated with the scheduled route.

Further, the method may further comprise the steps of calculating a probability of occurrence of a collision event on the scheduled route, by using the reconfigured application and information on the scheduled route of the vehicle; determining an alternative route for the vehicle, when the calculated probability of occurrence of the collision event value exceeds a preset threshold value; and transmitting the information on the determined alternative route to the vehicle.

Another aspect of the present invention, in a server for updating an application for autonomous driving of a vehicle in an automated vehicle and highway systems, the server comprising: a processor for controlling a function of the server; a transceiver coupled to the processor and configured to transmit and/or receive data for controlling the vehicle; and a memory coupled to the processor and configured to store data for controlling the vehicle, wherein the processor configured to control: acquiring at least one of i) sensor data, ii) processing data, iii) database (DB)-based data, or iv) external data associated with a specific event; generating a simulation model for the occurrence of the specific event based on the acquired data; tracking at least one object associated with the specific event based on the simulation model; updating an application for the autonomous driving based on a tracking result of the at least one object; and transmitting the information on the updated application to the vehicle.

Further, in the server, the specific event may be a collision event between the vehicle and another object.

Further, in the server, the processing data may be acquired by performing a processing operation for the autonomous driving on the sensor data, and the DB-based data may include at least one of geographic information, traffic information, or autonomous driving infrastructure information determined based on location information of the vehicle.

Further, in the server, the external data may include information on a surrounding environment and/or information on the at least one object when the collision event occurs.

Further, in the server, the simulation model may be generated based on the occurrence of the collision event designed based on the acquired data and a control operation of the vehicle to reproduce the occurrence of the collision event.

Further, in the server, the simulation model may operate based on an application installed in the vehicle when the collision event occurs.

Further, in the server, the processor may be further configured to control tracking objects in the order of high relevance, in consideration of relevance to the specific event, associated with tracking the at least one object associated with the specific event.

Further, in the server, a first object that collided with the vehicle may be assigned in a high priority of the relevance, and a second object associated only with the first object may be assigned in a low priority of the relevance.

Further, in the server, the processor may be further configured to track the objects in the order of high relevance to control identifying information of the object that causes the collision event.

Further, in the server, the processor may be further configured to control monitoring one or more objects determined using the information of the object that causes the collision event based on the updated application.

Further, in the server, the processor may be further configured to: control receiving information on a scheduled route of the vehicle from the vehicle; and control reconfiguring the updated application based on the information on the scheduled route of the vehicle.

Further, in the server, the information on the scheduled route of the vehicle may include at least one of i) traffic pattern information associated with the scheduled route, ii) weather information associated with the scheduled route, or iii) collision event information associated with the scheduled route.

Further, in the server, the processor may be further configured to: control calculating a probability of occurrence of a collision event on the scheduled route, by using the reconfigured application and information on the scheduled route of the vehicle; control determining an alternative route for the vehicle, when the calculated probability of occurrence of the collision event value exceeds a preset threshold value; and control transmitting the information on the determined alternative route to the vehicle.

According to an embodiment of the present invention, through data of past collision events (e.g., traffic accidents) in the autonomous driving system, applications, algorithms, and/or software may be updated to prevent occurrence of additional collision events of the vehicle.

It will be appreciated by persons skilled in the art that the effects that could be achieved with the present invention are not limited to what have been particularly described hereinabove and the above and other effects that the present invention could achieve will be more clearly understood from the following detailed description.

### BRIEF DESCRIPTION OF THE DRAWINGS

FIG. 1 is a block diagram of a wireless communication system to which methods proposed in the disclosure are applicable.

FIG. 2 shows physical channels and general signal transmission used in a 3GPP system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram referred to for describing a usage scenario of a user according to an exemplary embodiment of the present invention.

FIG. 10 is an example of V2X communication to which the present invention can be applied.

FIG. 11 illustrates a resource allocation method in the sidelink that V2X is used.

FIG. 12 is an example of a situation of occurrence of a collision event in an autonomous driving system according to an embodiment of the present invention.

FIG. 13 is an example of a block diagram of a vehicle control device and a server in an autonomous driving system according to an embodiment of the present invention.

FIG. 14 is an example of an operation flowchart of a server updating an application for autonomous driving of a vehicle in an autonomous driving system according to an embodiment of the present invention.

FIG. 15 is an example of signaling for updating an application for autonomous driving of a vehicle in an autonomous driving system according to an embodiment of the present invention.

FIG. 16 is an example of data used by a vehicle to update an application for autonomous driving in an autonomous driving system according to an embodiment of the present invention.

FIG. 17 is an example of an operation flowchart for generating a simulation model for updating an application in an autonomous driving system according to an embodiment of the present invention.

FIG. 18 is an example of a method for tracking an object related to a traffic accident in an autonomous driving system according to an embodiment of the present invention.

FIG. 19 is an example of a reconstruction method of a simulation model according to a driving route of a vehicle in an autonomous driving system according to an embodiment of the present invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

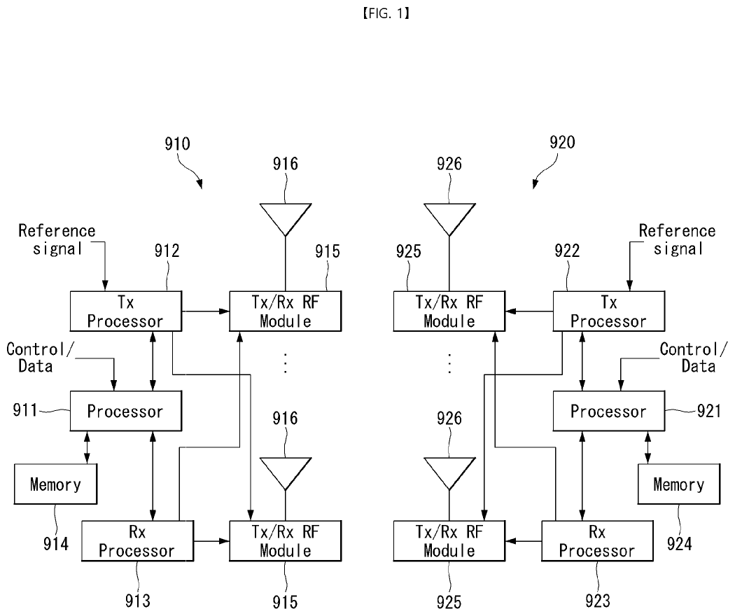

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Method of Transmitting/Receiving Signals in Wireless Communication System

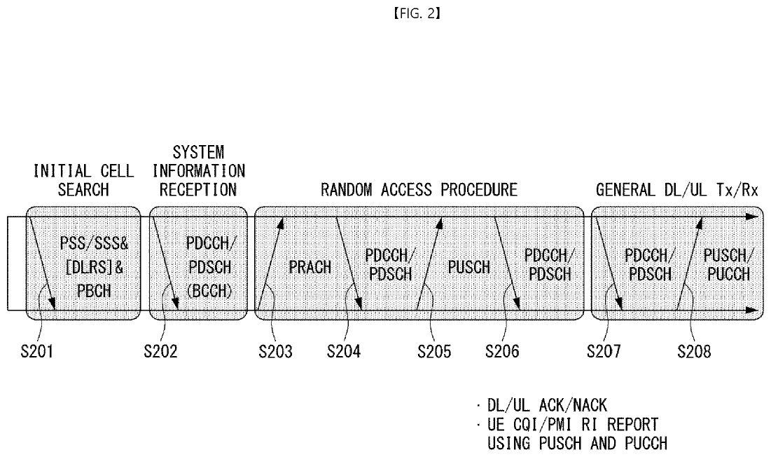

FIG. 2 shows physical channels and general signal transmission used in a 3GPP system. In a wireless communication system, the UE receives information through a downlink (DL) from a base station, and the UE transmits the information through an uplink (UL) to the base station. The information transmitted and received between the base station and the UE includes data and various control information, and various physical channels exist according to the type/use of the information transmitted and received by base station and the UE.

If the UE is powered on or enters a new cell, the UE performs an initial cell search operation such as synchronizing with the base station (S201). To this end, the UE may receive a Primary Synchronization Signal (PSS) and a Secondary Synchronization Signal (SSS) from the base station to synchronize with the base station and acquire information such as a cell ID. Thereafter, the UE may receive a physical broadcast channel (PBCH) from the base station to acquire broadcast information in a cell. Meanwhile, the UE may check a downlink channel state by receiving a downlink reference signal (DL RS) in an initial cell search step.

Upon completion of the initial cell search, the UE may acquire more specific system information, by receiving a physical downlink control channel (PDSCH) according to a physical downlink control channel (PDCCH) and information on the PDCCH (S202).

Meanwhile, when accessing firstly to the base station or there is no radio resource for signal transmission, the UE may perform a random access procedure (RACH) for the base station (S203 to S206). To this end, the UE may transmit a specific sequence as a preamble through a physical random access channel (PRACH) (S203 and S205), and receive a response message (RAR (Random Access Response) message to the preamble through the PDCCH and the corresponding PDSCH. In the case of contention-based RACH, a contention resolution procedure may be additionally performed (S206).

After performing the procedure as described above, the UE performs a PDCCH/PDSCH reception (S207) and a physical uplink shared channel (PUSCH)/physical uplink control channel (PUCCH) transmission (S208) as a general uplink/downlink signal transmission procedure. In particular, the UE may receive downlink control information (DCI) through the PDCCH. Here, the DCI includes control information such as resource allocation information for the UE, and the format may be applied differently according to the purpose of use.

Meanwhile, the control information transmitted by the UE to the base station through the uplink or received by the UE from the base station may include a downlink/uplink ACK/NACK signal, a channel quality indicator (CQI), a precoding matrix index (PMI), a rank indicator (RI)) and the like. The UE may transmit the above-described control information such as CQI/PMI/RI through PUSCH and/or PUCCH.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent path loss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation between Autonomous Vehicles using 5G Communication

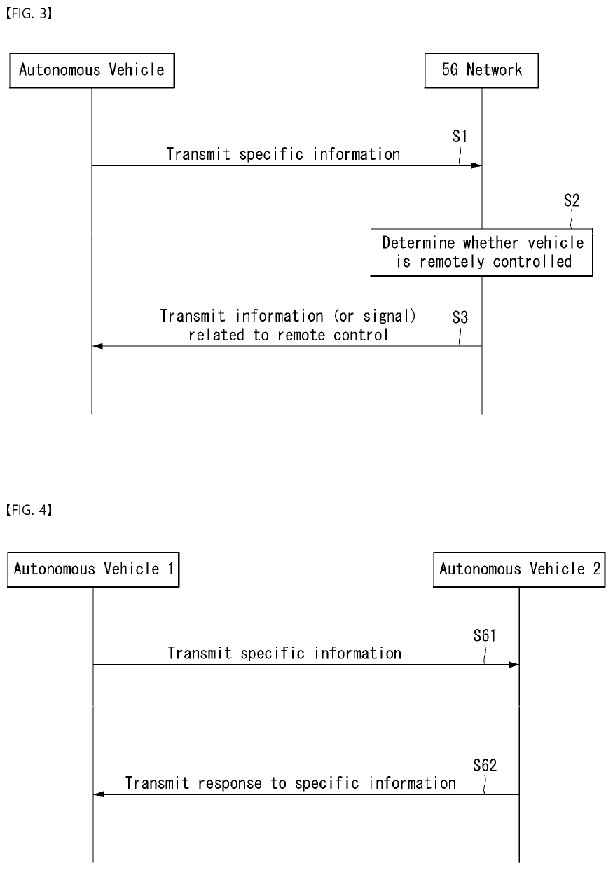

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation between Vehicles using 5G Communication

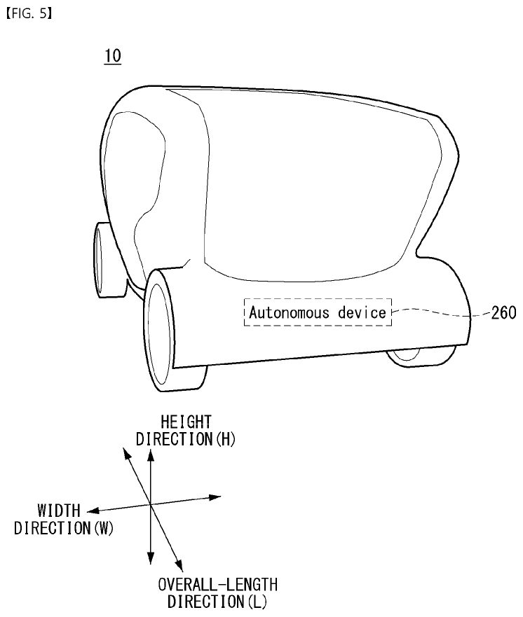

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (side-link communication transmission mode 3) or indirectly (side-link communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical side-link control channel (PSCCH) is a 5G physical channel for scheduling of transmission of specific information a physical side-link shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

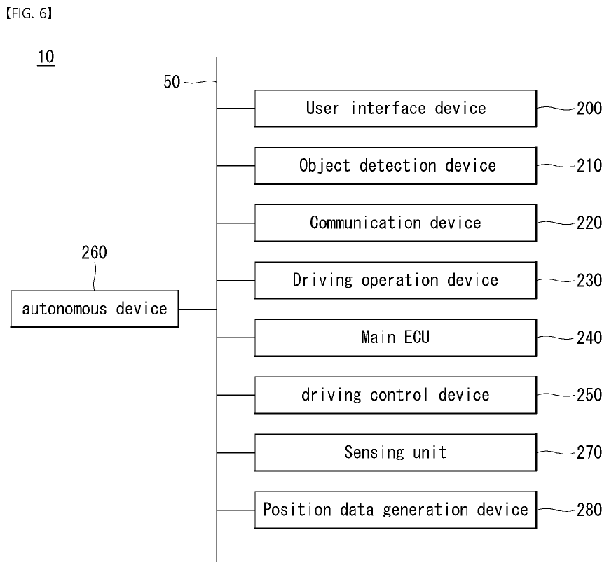

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

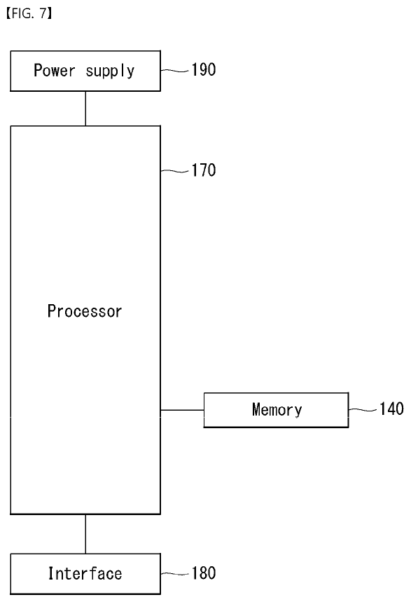

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include side-link communication based on LTE and/or side-link communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

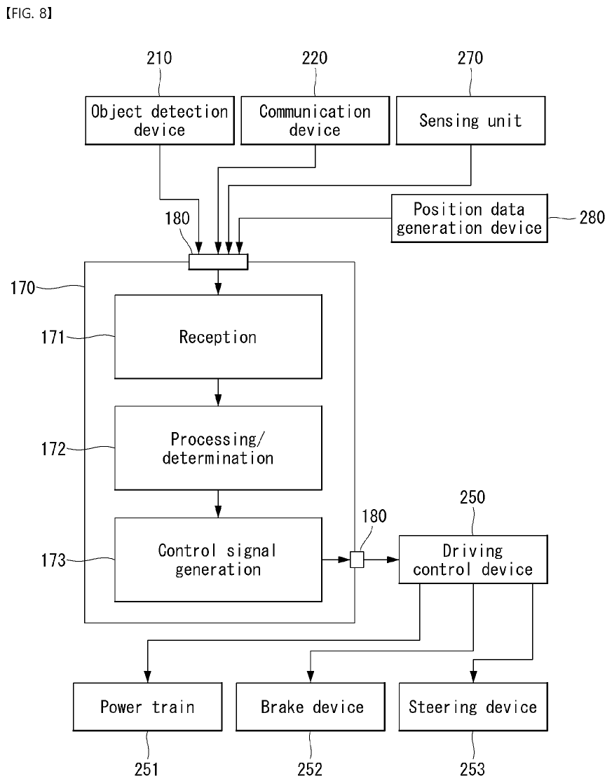

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

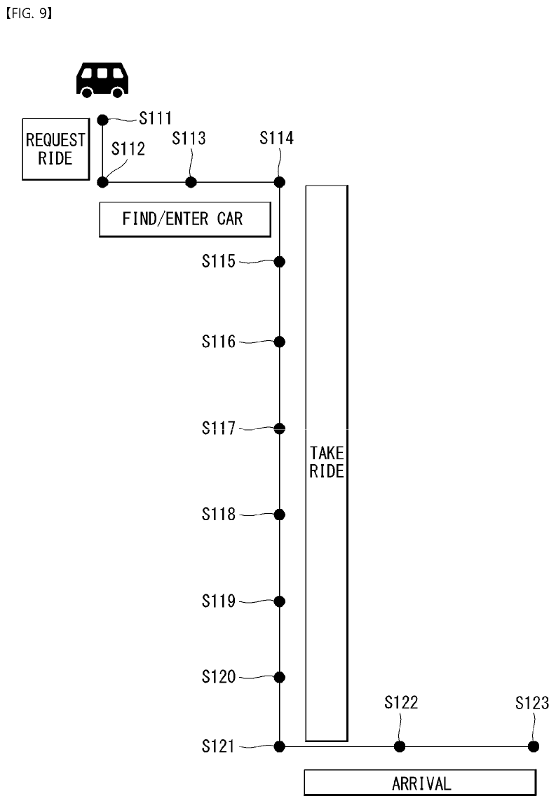

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 253.

Autonomous Vehicle Usage Scenario

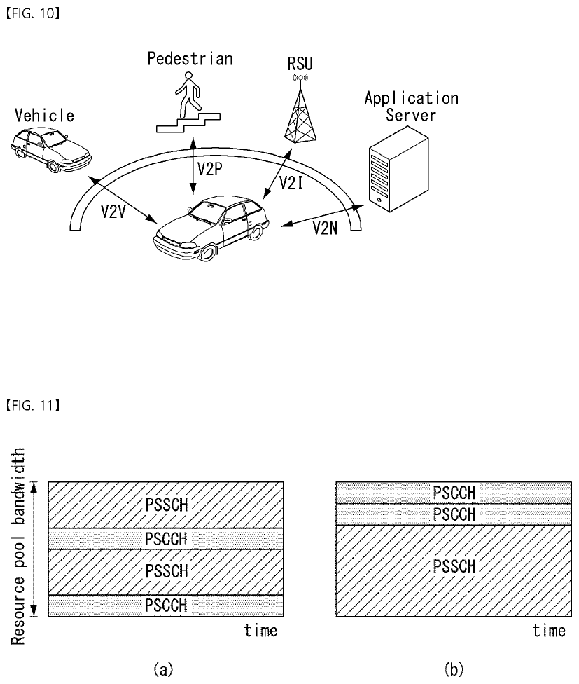

FIG. 9 is a diagram referred to describe a usage scenario of the user according to an embodiment of the present invention.

1) Destination Forecast Scenario

A first scenario S111 is a destination forecast scenario of the user. A user terminal may install an application that can be linked with a cabin system 300. The user terminal can forecast the destination of the user through the application based on user's contextual information. The user terminal may provide vacant seat information in a cabin through the application.

2) Cabin Interior Layout Countermeasure Scenario

A second scenario S112 is a cabin interior layout countermeasure scenario. The cabin system 300 may further include a scanning device for acquiring data on the user located outside a vehicle 300. The scanning device scans the user and can obtain physical data and baggage data of the user. The physical data and baggage data of the user can be used to set the layout. The physical data of the user can be used for user authentication. The scanning device can include at least one image sensor. The image sensor can use light in a visible light band or an infrared band to acquire an image of the user.

The seat system 360 can set the layout in the cabin based on at least one of the physical data and baggage data of the user. For example, the seat system 360 may provide a baggage loading space or a seat installation space.

3) User Welcome Scenario

A third scenario S113 is a user welcome scenario. The cabin system 300 may further include at least one guide light. The guide light may be disposed on a floor in the cabin. The cabin system 300 may output the guide light such that the user is seated on the seat, which is already set among the plurality of sheets when user's boarding is detected. For example, a main controller 370 may implement moving light through sequential lighting of a plurality of light sources according to the time from an open door to a predetermined user seat.

4) Seat Adjustment Service Scenario

A fourth scenario S114 is a seat adjustment service scenario. The seat system 360 may adjust at least one element of the seat that matches the user based on the acquired physical information.

5) Personal Content Provision Scenario

A fifth scenario S115 is a personal content provision scenario. A display system 350 can receive personal data of the user via an input device 310 or a communication device 330. The display system 350 can provide a content corresponding to the personal data of the user.

6) Product Provision Scenario

A sixth scenario S116 is a product provision scenario. A cargo system 355 can receive user data through the input device 310 or the communication device 330. The user data may include preference data of the user and destination data of the user. The cargo system 355 may provide a product based on the user data.

7) Payment Scenario

A seventh scenario S117 is a payment scenario. A payment system 365 can receive data for price calculation from at least one of the input device 310, the communication device 330 and the cargo system 355. The payment system 365 can calculate a vehicle usage price of the user based on the received data. The payment system 365 can require the user (that is, mobile terminal of user) to pay a fee at the calculated price.

8) User Display System Control Scenario

An eighth scenario S118 is a user display system control scenario. The input device 310 may receive a user input configured in at least one form and may convert the user input into an electrical signal. The display system 350 can control a content displayed based on the electrical signal.

9) AI Agent Scenario

A ninth scenario S119 is a multi-channel artificial intelligence (AI) agent scenario for multiple users. An AI agent 372 can distinguish the user input of each of multiple users. The AI agent 372 can control at least one of the display system 350, the cargo system 355, the seat system 360, and the payment system 365 based on the electric signal converted from the user input of each of the multiple users.

10) Multimedia Content Provision Scenario for Multiple Users

A tenth scenario S120 is a multimedia content provision scenario for multiple users. The display system 350 can provide a content that all users can view together. In this case, the display system 350 can individually provide the same sound to multiple users through a speaker provided in each sheet. The display system 350 can provide a content that the multiple users individually can view. In this case, the display system 350 can provide an individual sound through the speaker provided in each sheet.

11) User Safety Securing Scenario

An eleventh scenario S121 is a user safety securing scenario. When vehicle peripheral object information that poses a threat to the user is acquired, the main controller 370 can control to output an alarm of the vehicle peripheral object via the display system 350.

12) Belongings Loss Prevention Scenario

A twelfth scenario S122 is a scenario for preventing loss of belongings of the user. The main controller 370 can obtain data on the belongings of the user via the input device 310. The main controller 370 can obtain user motion data through the input device 310. The main controller 370 can determine whether the user places the belongings and gets off based on the data of the belongings and the motion data. The main controller 370 can control to output an alarm of the belongings through the display system 350.

13) Get Off Report Scenario

A thirteenth scenario S123 is a get off report scenario. The main controller 370 can receive get off data of the user through the input device 310. After the user gets off, the main controller 370 can provide report data for the get off to the mobile terminal of the user through the communication device 330. The report data may include the entire usage fee data of the vehicle 10.

Vehicle-to-Everything (V2X)

FIG. 10 is an example of V2X communication to which the present invention is applicable.

The V2X communication includes communication between a vehicle and all objects such as Vehicle-to-Vehicle (V2V) referring to communication between vehicles, Vehicle-to-Infrastructure (V2I) referring to communication between a vehicle and an eNB or a Road Side Unit (RSU), and Vehicle-to-Pedestrian (V2P) or a Vehicle-to-Network (V2N) referring to communication between a vehicle and a UE with an individual (pedestrian, bicycler, vehicle driver, or passenger).

The V2X communication may indicate the same meaning as V2X side-link or NR V2X, or may include a broader meaning including the V2X side-link or NR V2X.

For example, the V2X communication can be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication can be provided via a PC5 interface and/or a Uu interface. In this case, in a wireless communication system that supports the V2X communication, there may exist a specific network entity for supporting the communication between the vehicle and all the objects. For example, the network object may be a BS (eNB), the road side unit (RSU), a UE, an application server (for example, a traffic safety server), or the like.

In addition, the UE executing V2X communication includes not only a general handheld UE but also a vehicle UE (V-UE), a pedestrian UE, a BS type (eNB type) RSU, a UE type RSU, a robot having a communication module, or the like.

The V2X communication may be executed directly between UEs or may be executed through the network object(s). V2X operation modes can be divided according to a method of executing the V2X communication.

The V2X communication requires a support for UE pseudonymity and privacy when a V2X application is used so that an operator or a third party cannot track a UE identifier within a V2X support area.

Terms frequently used in the V2X communication are defined as follows.

Road Side Unit (RSU): The RSU is a V2X serviceable device that can perform transmission/reception with a moving vehicle using a V2I service. Furthermore, the RSU can exchange messages with other entities supporting the V2X application as a fixed infrastructure entity supporting the V2X application. The RSU is a term often used in the existing ITS specifications, and a reason for introducing this term in 3GPP specifications is to make it easy to read a document in an ITS industry. The RSU is a logical entity that combines a V2X application logic with functions of a BS (referred to as BS-type RSU) or a UE (referred to as UE-type RSU).

V2I service: A type of V2X service in which one is a vehicle and the other is an entity belongs to an infrastructure.

V2P service: A type of the V2X service in which one is a vehicle and the other is a device (for example, handheld UE carried by pedestrian, bicycler, driver, or passenger) carried by an individual.

V2X service: A 3GPP communication service type in which a transmitting or receiving device is related to a vehicle.

V2X enabled UE: A UE supporting the V2X service.

V2V service: A type of the V2X service in which both in the communication are vehicles.

V2V communication range: A range of direct communication between two vehicles participating in the V2V service.

As described above, the V2X application referred to as the V2X (Vehicle-to-Everything) includes four types such as (1) Vehicle-to-Vehicle (V2V), (2) Vehicle-to-infrastructure (V2I), (3) Vehicle-to-Network (V2N), and (4) Vehicle-to-Pedestrian (V2P).

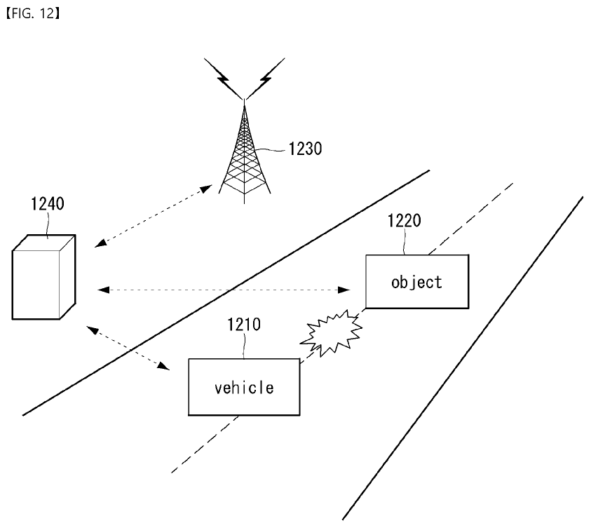

FIG. 11 shows a resource allocation method in a side-link where the V2X is used.

In the side-link, different physical side-link control channels (PSCCHs) may be separately allocated in a frequency domain, and different physical side-link shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP release 14 and 15, supports for the V2V and V2X services are introduced in LTE.

Requirement for supports with respect to an enhanced V2X use case are broadly divided into four use case groups.

(1) A Vehicle Platooning can dynamically form a platoon in which vehicles move together. All vehicles in the platoon get information from the top vehicle to manage this platoon. These pieces of information allow the vehicles to be operated in harmony in the normal direction and to travel together in the same direction.

(2) Extended sensors can exchange raw data or processed data collected by a local sensor or a live video image in a vehicle, a road site unit, a pedestrian device, and a V2X application server. In the vehicle, it is possible to raise environmental awareness beyond what a sensor in the vehicle can sense, and to ascertain broadly and collectively a local situation. A high data transmission rate is one of main features.

(3) Advanced driving allows semi-automatic or full-automatic driving. Each vehicle and/or the RSU shares own recognition data obtained from the local sensor with a proximity vehicle and allows the vehicle to synchronize and coordinate a trajectory or maneuver. Each vehicle shares a driving intention with the proximity vehicle.

(4) Remote driving allows a remote driver or the V2X application to drive the remote vehicle for a passenger who cannot drive the remote vehicle in his own or in a dangerous environment. If variability is restrictive and a path can be forecasted as public transportation, it is possible to use Cloud computing based driving. High reliability and a short waiting time are important requirements.

The above-described 5G communication technology can be combined with methods proposed in the present invention which will be described later and applied or can complement the methods proposed in the present invention to make technical features of the methods concrete and clear.

The introduction of autonomous driving technology as described above may be expected to reduce the probability of occurrence of a collision event (e.g., a traffic accident) due to human error. However, unless all vehicles are changed to autonomous vehicles, a collision event may occur in a situation where a manual driving vehicle, an autonomous vehicle, a motorcycle, and the like are mixed.

For example, a large amount of driving data may be acquired in accordance with the expanding dissemination of autonomous vehicles, and in particular, the amount of data collected about the crash event may be increased. A method of collecting data on a crash event through an autonomous vehicle and utilizing the collected data in deep learning of a program for perception, determination, and/or control of autonomous driving may be considered.

In consideration of this, in relation to the occurrence of a specific event for the vehicle, in particular, the collision event (e.g., a traffic accident), the present invention proposes a technique for updating an autonomous driving application based on the data acquired from the vehicle itself and/or the data acquired through communication with object(s) located outside the vehicle (e.g., V2X, P2P, etc.).

In the present invention, for convenience of explanation, only self-driving application is described as a reference, and the present invention can be also extended to apply for updating a program, a code, an instruction, an algorithm, a software for autonomous driving. In other words, in the present invention, the autonomous driving application may be replaced with at least one of a program, a code, an instruction, an algorithm, and/or software for autonomous driving.

Hereinafter, various embodiments of the present disclosure will be described in detail with reference to the accompanying drawings.

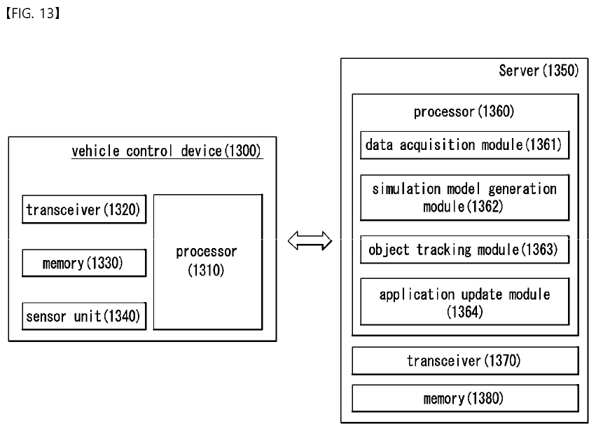

FIG. 12 is an example of a situation of occurrence of a collision event in an autonomous driving system according to an embodiment of the present invention. FIG. 12 is merely for convenience of description and does not limit the scope of the invention.

Referring to FIG. 12, the autonomous driving system may include a vehicle 1210 in which a control in accordance with an embodiment of the present invention is performed, an object 1220 in which there is a possibility of collision with the vehicle 1210, a device 1230 performing management and control related to the autonomous driving, and a server 1240 managing data related to the autonomous driving of the vehicle 1210. Here, the vehicle 1210 may be a vehicle equipped with the autonomous driving function as described above.

In FIG. 12, it is assumed that the vehicle 1210 collides with the object 1220, and in this case, the object 1220 may cause a collision event with the autonomous vehicle such as another autonomous vehicle, a pedestrian, a motorcycle, a bicycle, and the like. In FIG. 12, although the object 1220 is shown as one object, this is for convenience of description only and it may be one or more objects that may collide with the vehicle 1210.

In addition, the device 1230 may perform management of autonomous driving-related matters (e.g., movement, driving, etc.) of the vehicle 1210. In addition, the device 1230 may transmit information for autonomous driving of the vehicle 1210 to the server 1240.

In addition, data related to autonomous driving of the vehicle 1210 may be stored in the server 1240. For example, the data may be managed in the form of a database (DB), and may be transmitted to the autonomous vehicle through a wireless communication system (e.g., P2P, V2X, etc.). In addition, the server 1240 may update an application, an algorithm, software, or the like for autonomous driving of the vehicle 1210.

When the vehicle 1210 collides with the object 1220, that is, when a collision event (e.g., a traffic accident) occurs between the vehicle 1210 and the object 1220, the server 1240 may acquire data related to the collision event. For example, the server 1240 may acquire (or receive) data which is itself acquired by the vehicle 1210 related to the collision event from the vehicle 1210. In addition, the server 1240 may acquire (or receive) data related to the collision event from the object 1220. In addition, the server 1240 may acquire (or receive) data related to the collision event from the device 1230. In addition, the server 1240 may acquire (or extract) data related to the collision event from a stored database (DB). Communication between the vehicle 1210, the object 1220, the device 1230, and/or the server 1240 may be based on the network infrastructure and signal transmission and reception procedures described with reference to FIGS. 1 to 4.

Based on the data acquired as described above, the server 1240 may update the autonomous driving application. That is, based on the data acquired as described above, the server 1240 may modify, add, and/or update a program, a code, an instruction, a software, etc. in order to prevent additional occurrence of a collision event.

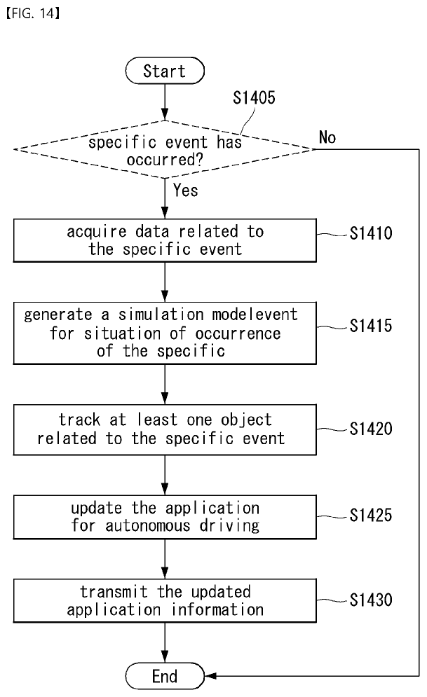

FIG. 13 is an example of a block diagram of a vehicle control device and a server in an autonomous driving system according to an embodiment of the present invention. The vehicle control device 1300 of FIG. 13 shows an example of a device configured in the vehicle 1210 to control the vehicle 1210 of FIG. 12. In addition, the server 1350 of FIG. 13 may be the server 1240 of FIG. 12. FIG. 13 is merely for convenience of description and does not limit the scope of the present invention.

The vehicle control device 1300 of FIG. 13 may be configured as part of the autonomous vehicle 260 described with reference to FIG. 5.

For example, the processor 1310 of FIG. 13 is configured as at least one processing circuitry for controlling a function of the vehicle 1210, and may perform the same function as the driving manipulation device 230 and the main ECU 240 of FIG. 6. In addition, the processor 1310 may be configured to perform the same or similar function as the processor 170 illustrated in FIGS. 7 and 8, or the processor 371 or the Al agent 372 included in the main controller in FIG. 10.

The transceiver 1320 of FIG. 13 is a component functionally coupled with the processor 1310 and may transmit or receive data for controlling the vehicle 1210. The transceiver 1320 may include at least one antenna, an RF processing module, a frequency converter, and a baseband processing module for transmitting or receiving a signal. The transceiver 1320 of FIG. 13 may be configured as the first communication device 910 or the second communication device 920 of FIG. 1, or may perform the same function as the communication device 220 of FIGS. 6 and 8.

The memory 1330 of FIG. 13 is a component functionally coupled with the processor 1310 to store data for controlling the vehicle 1200. The memory 1300 may be configured of at least one memory element for storing data. The memory 1300 of FIG. 13 may be configured to perform the same function as the memory 140 of FIG. 7.

The sensor unit 1340 of FIG. 13 is a component functionally coupled with the processor 1310 and may generate information on a situation and/or an object around the vehicle 1210. The sensor unit 1210 may include at least one of camera, radar, a lidar, an ultrasonic sensor, an infrared sensor, a global positioning system (GPS), an inertial measurement unit (IMU), and the like. The sensor unit 1340 of FIG. 13 may perform the same function as the object detection device 210 of FIGS. 6 and 8.

The server 1350 of FIG. 13 may include a processor 1360, a transceiver 1370, and a memory 1380.

For example, the processor 1360 may be configured with at least one processing circuitry for controlling the function of the server 1350. The processor 1360 may include a data acquisition module 1361, a simulation model generation module 1362, an object tracking module 1363, and an application update module 1364.

Here, the data acquisition module 1361 may be used to acquire any one of i) sensor data, ii) processing data, iii) a database (DB)-based data and/or iv) external data related to a specific event, in particular a crash event (e.g., a traffic accident) of a vehicle. In addition, the simulation model generation module 1362 may be used to generate a simulation model for the occurrence situation of the specific event, based on the data acquired by the data acquisition module 1361. In addition, the object tracking module 1363 may be used to track at least one object associated with the specific event based on the simulation model generated by the simulation model generation module 1362. In addition, the application update module 1364 may be used to update the autonomous driving application for the vehicle control device 1300 based on the tracking result of the at least one object determined by the object tracking module 1363.

The transceiver 1370 is a component functionally coupled with the processor 1360 and may transmit or receive data for controlling the vehicle 1210. The transceiver 1370 may include at least one antenna, an RF processing module, a frequency converter, and a baseband processing module for transmitting or receiving a signal. For example, the transceiver 1370 may transmit information on the updated application based on the above-described schemes to the vehicle control device 1300.

The memory 1380 is a component functionally coupled with the processor 1360 and stores data for controlling the server 1350. The memory 1380 may be configured of at least one memory element for storing data.

Configurations of the vehicle control device 1300 and the server 1350 shown in FIG. 13 are merely exemplary, and may include various additional components for controlling the vehicle, or at least some of the components illustrated in FIG. 13 may be omitted or may be replaced.

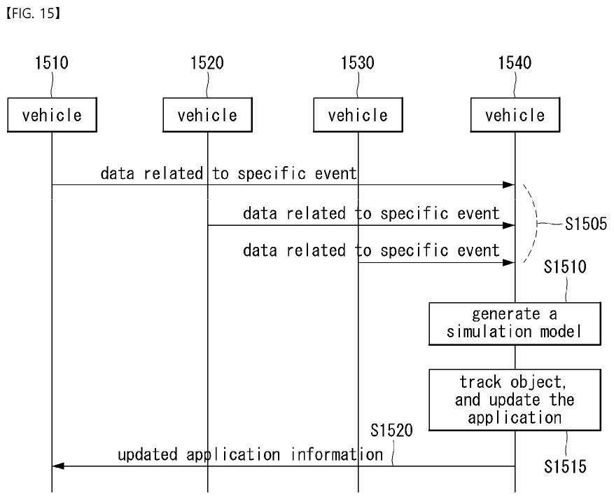

FIG. 14 is an example of an operation flowchart of a server updating an application for autonomous driving of a vehicle in an autonomous driving system according to an embodiment of the present invention. FIG. 14 is merely for convenience of description and does not limit the scope of the present invention.

Referring to FIG. 14, a specific event occurs between a vehicle and an object, and a method of updating an autonomous driving application of a vehicle based on data according to the specific event is proposed. For example, the specific event may be a collision event (e.g., a traffic accident) between the vehicle and another object.

The server may check whether a specific event has occurred (S1405). For example, the server may check whether a traffic accident between the autonomous vehicle and another object occurs. For example, the server may determine whether a traffic accident has occurred by checking information acquired using a collision detection sensor, a camera, or the like of the vehicle, information on an autonomous driving infrastructure, and the like.

When a specific event does not occur, the server may not perform an operation of updating an application for autonomous driving.

On the other hand, when a specific event occurs, the server may acquire data related to the specific event (S1410). As an example, the acquiring step of the data may be controlled by the data acquiring module 1361 described with reference to FIG. 13.

Here, the data may be at least one of i) sensor data, ii) processing data, iii) database (DB)-based data, and/or iv) external data.

The sensor data may be acquired through a sensor unit (e.g., the sensor unit 1340 of FIG. 13) of the vehicle. In addition, the processing data may be acquired by a server performing a processing operation for the autonomous driving on the sensor data. In other words, the process data may be data that is output by performing a perception operation, a decision operation, and/or a control operation on the sensor data. In addition, the DB-based data may include at least one of geographic information, traffic information, and/or autonomous driving infrastructure information determined based on the location information of the vehicle. In addition, the external data may include information on the surrounding environment and/or information on the at least one object when the collision event occurs. The external data may be received from a vehicle, another object, and/or a device (e.g., RSU, base station, etc.) that manages autonomous driving of the vehicle.

The server may generate a simulation model for situation of occurrence of the specific event based on the acquired data (S1415). In one example, generating the simulation model may be controlled by the simulation model generation module 1362 described with reference to FIG. 13.

For example, the server may generate a simulation model for reproducing the situation of a traffic accident using (or inputting) acquired sensor data, processing data, DB-based data, and/or external data.

The simulation model may be generated based on a control operation for reproducing a situation of occurrence of a collision event designed based on the acquired data. In addition, the simulation model may be configured to operate based on an application installed when the collision event occurs.

The server may track at least one object related to the specific event based on the generated simulation model (S1420). In one example, the step of tracking the at least one object may be controlled by the object tracking module 1363 described in FIG. 13.

For example, the step of tracking at least one object related to the specific event may include the step of tracking the objects in the order of high relevance in consideration of relevance to the specific event. In addition, a first object that has collided directly with the vehicle is assigned as a high priority of relevance, and a second object associated with only the first object (i.e., an object that does not directly collide with the vehicle but is associated with the first object) can be assigned as a low priority of the relevance. In addition, the server can identify the object information causing the collision event by tracking the objects in the order of high relevance. That is, the server may identify the root cause causing the traffic accident of the vehicle by using the multi-step backtracking technique as described above.

The server may update the application for autonomous driving based on the tracking result of the at least one object (S1425). For example, the step of updating of the application may be controlled by the application update module 1364 described with reference to FIG. 13.

For example, the server may identify an item of an application (or an item of an algorithm, an item of software) that needs to be modified to prevent further traffic accidents, and update (and/or modify the identified item(s). In this case, information on the cause of the traffic accident checked based on the tracking result may be used.

In addition, the server may transmit information on the updated application to the vehicle (S1430). When the application is updated through the above-described procedures, the server and/or the vehicle may monitor one or more objects determined based on the information of the object causing the collision event. By monitoring together with the target object that the direct collision with the vehicle is expected, as well as the object(s) that may correspond to the root cause associated with the target object, there is an effect of preventing a traffic accident.

Each step described in FIG. 14 is merely exemplary, and some of the steps may be omitted or replaced, and one or more steps may be combined (i.e., performed simultaneously).

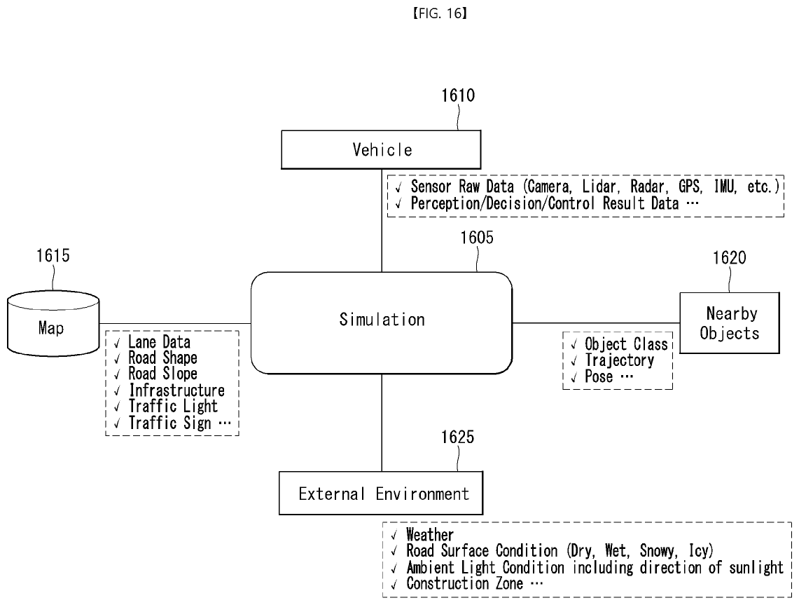

FIG. 15 is an example of signaling for updating an application for autonomous driving of a vehicle in an autonomous driving system according to an embodiment of the present invention. FIG. 15 is merely for convenience of description and does not limit the scope of the present invention.

Referring to FIG. 15, a specific event occurs between a vehicle and an object, and a method of updating an autonomous driving application of a vehicle based on data according to the specific event is proposed. For example, the specific event may be a collision event (e.g., a traffic accident) between the vehicle and another object.

In FIG. 15, a vehicle 1510, an object 1520, a device 1530, and a server 1540 are described with the vehicle 1210, the object 1220, the device 1230, and the server 1240 described in FIG. 12.

The server 1540 may receive data related to a specific event from the vehicle 1510, the object 1520, and/or the device 1530 (S1505). For example, as described with reference to FIGS. 13 and 14, server 1540 may acquire (receive) at least any one of i) sensor data, ii) processing data, iii) database (DB)-based data and/or iv) external data related to the specific event.

The server 1540 may generate a simulation model based on the acquired (or received) data (S1510). For example, as described in FIGS. 13 and 14, the server 1540 may generate a simulation model to reproduce the situation of traffic accidents by using (or inputting) the acquired sensor data, processing data, DB-based data, and/or external data etc.

The server 1540 may track at least one object related to a specific event based on the generated simulation model, and update the application for autonomous driving of the vehicle based on the tracking result (S1515). For example, as described in FIGS. 13 and 14, the server 1540 may track not only objects directly related to a specific event (e.g., collision event) between the vehicle and the object, but also objects that are indirectly related to the specific event. In addition, the server 1540 may update the application (or algorithm, software, etc.) for autonomous driving by identifying the root cause of the occurrence of a specific event based on the tracking of the object, and identifying items that need to be modified.

The server 1540 may transmit information on the updated application to the vehicle (S1520). Through this, an updated application may be applied to the vehicle, and the server and/or the vehicle may prevent the occurrence of a specific event by monitoring the root cause during autonomous driving.

Hereinafter, assuming that the specific event corresponds to a collision event (e.g., a traffic accident), a detailed example of the steps described in FIGS. 14 and 15 will be described. For convenience of explanation, the examples are described based on the fact that the collision event is a traffic accident, but the description below may be also applied to extend even when another collision event or another type of event requiring an update of an application of the vehicle occurs.

Example Related to Data Acquisition Steps S1410 and S1505

First, steps S1410 and S1505 related to data acquisition of a vehicle will be described in detail. Data acquirable by a vehicle in relation to a traffic accident may be configured as shown in the following example.

For example, the sensor data may be sensor raw data. Here, the sensor row data may refer to data collected through the sensor unit (e.g., the sensor unit 1340 of FIG. 13) of the vehicle and which have not been processed. The sensor raw data may be necessary to reproduce the process of processing the sensor data in the autonomous vehicle at the time of occurrence of the traffic accident as it is.

Further, in order to verify the intermediate result that the sensor raw data is output through the perception processing, the determination processing, and/or the control processing in the autonomous driving application (i.e., autonomous driving software), data output in the perception processing, the determination process and/or the control process may also be collected (or acquired).

In addition, the external data related to the traffic accident may refer to data that can be acquired through wireless communication (e.g., V2X, etc.) from another vehicle, an RSU, a base station, etc. in addition to the vehicle. Through this, data that cannot be acquired from the vehicle itself may be secured. The external data related to the traffic accident may be used to reproduce the situation of the traffic accident, or may be used for comparison with data collected from the vehicle.

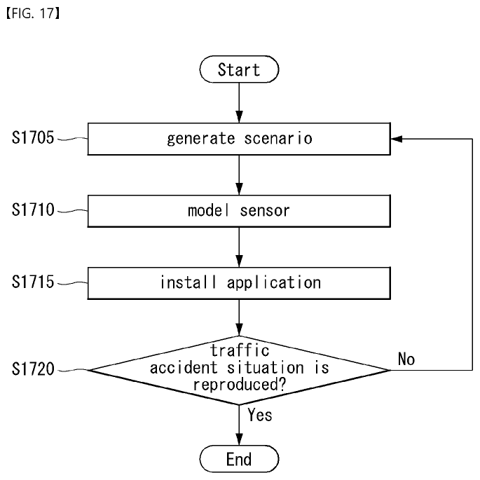

FIG. 16 is an example of data used by a vehicle to update an application for autonomous driving in an autonomous driving system according to an embodiment of the present invention. FIG. 16 is merely for convenience of description and does not limit the scope of the present invention.

Referring to FIG. 16, it is assumed that a traffic accident occurs between a vehicle and another object as in the above example, and an example of input data of a simulation 1605 for reproducing a traffic accident is shown. The contents described with reference to FIG. 16 may be related to the steps S1410 and S1505 of acquiring data by the server in FIGS. 14 and 15.

For example, for a simulation to reproduce the traffic accident, data 1610 that can be acquired from the vehicle itself, DB-based data 1615, data 1620 for proximity objects, and data 1625 for the external environment, may be acquired and input.

Here, the data 1610 that may be acquired in the vehicle itself may include sensor row data, perception/determination/control result data, and the like. Here, the sensor raw data may include not only data acquired by a camera, a lidar, and a radar, but also result data of GPS and IMU sensors capable of confirming position and pose information of the vehicle.

In addition, as DB-based data 1615, map information of the corresponding location set based on the location information of the vehicle may be acquired from a Map DB. The map information may include information needed to construct the simulation model, such as lane data, a road shape, a road slope, an infrastructure, a traffic light, a traffic sign, and the like at a traffic accident site.

In addition, the data 1620 for the proximity object may refer to information on the object(s) around the vehicle related to the traffic accident. The data may be received directly from the object(s) around the vehicle, or may be generated based on information acquired (or received) via the vehicle itself, RSU, V2X, or the like. Here, the data may include information on a class, a trajectory, a pose, etc. of the proximity object.

In addition, the data 1625 about the external environment may include information on the surrounding environment at the time of the occurrence of the traffic accident. The data may be acquired from the vehicle itself or transmitted from a server or the like related to autonomous driving of the vehicle. Here, the data may include information used for weather, road surface condition, ambient light condition, direction of sunlight, construction zone, and the like at the time of the occurrence of the traffic accident.

Example Related to Simulation Model Generation Step (S1415, S1510)

Next, the steps (S1415 and S1510) of generating a simulation model based on the acquired data will be described in detail. A simulation model for a traffic accident occurrence situation may be generated as shown in the following example.

For example, the server may perform modeling to reconstruct information on the movement trajectory and the pose of the vehicle and the proximity objects as time varies at the time of occurrence of the traffic accident, the map information of the corresponding location, and the like. In addition, the server can reproduce the traffic accident situation by realistically modeling as possible the surrounding environment information such as weather, road surface condition, ambient brightness condition, sun position, etc., which may affect the traffic accident. That is, the server can model the situation at the time of the traffic accident by using the collected traffic accident data and surrounding environment information, and reproduce the traffic accident situation based on the time axis.

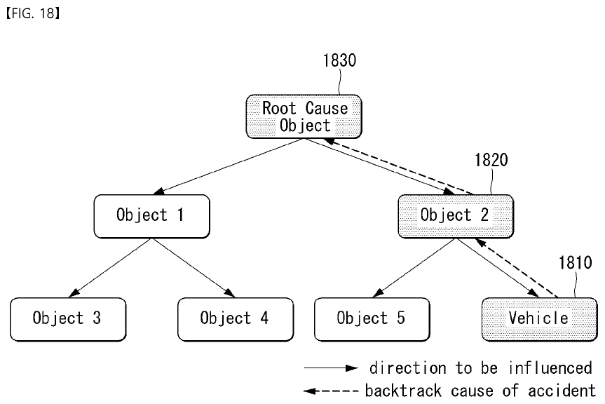

FIG. 17 is an example of an operation flowchart for generating a simulation model for updating an application in an autonomous driving system according to an embodiment of the present invention. FIG. 17 is merely for convenience of description and does not limit the scope of the present invention.

Referring to FIG. 17, it is assumed that a server generates a simulation environment to repeatedly reproduce a traffic accident situation based on the acquired (or collected) data, and find a solution to prevent further traffic accidents. The server in FIG. 17 may be the server described in FIGS. 12 to 16.

The server may generate a scenario of the situation that a traffic accident occurs (S1705). For example, based on the data acquired, the server may generate a scenario of the traffic accident occurrence situation such as roads, infrastructure, vehicles (i.e. the subject of traffic accidents), proximity objects, weather, road conditions, direction of sunlight, and the like.

The server may model the sensor mounted on the vehicle (S1710). For example, the server may create an environment that operates in the same manner as when a traffic accident occurs by modeling a sensor such as a camera, a radar, a rider, and the like mounted on a vehicle. Alternatively, the server may input sensor raw data directly into an autonomous processor or processing application (or algorithm, software) module.

The server may install an application installed at the time of the occurrence of traffic accident of the vehicle for generating a simulation model (S1715). For example, the server may install the autonomous driving application used at the time of the occurrence of traffic accident of the vehicle in the simulation environment to reproduce the traffic accident situation of the vehicle as it is.

The server may check whether the traffic accident situation of the vehicle is identically reproduced (S1720). If the traffic accident situation of the vehicle is identically reproduced, the server may end the simulation model generation operation. On the other hand, if the traffic accident situation of the vehicle is not identically reproduced, the server may start again from the beginning of the simulation model generation operation, that is, the scenario generation step (S1705).

If the traffic accident situation is identically reproduced, the server may perform an operation of identifying the root cause of the traffic accident. Once the root cause is identified, the server may identify and update the improvement item(s) of the autonomous driving application that can prevent the traffic accident. In addition, the server may generate and check various scenarios as to whether other side effects caused by application modification occur.

Example Relating to the Object Tracking Step (S1420, S1515)

Next, the steps S1420 and S1515 of tracking an object related to a traffic accident based on the generated simulation model will be described in detail. Tracking of objects related to traffic accidents may be based on multi-level backtracking techniques. That is, a method of simply traking back to the root cause through a directly colliding object starting from a vehicle in which a traffic accident occurs may be used. The server may identify the cause of the traffic accident through the multi-level backtracking technique, and then derive a method to prevent future traffic accidents.

For example, if there is a cyclist and a second vehicle following it in front of the next lane to a first vehicle, the first vehicle is highly likely to overtake the bicycle in some violations of its lane to avoid the bicycle. In this case, when the first vehicle is located in the blind spot of the second vehicle, a side collision accident is highly likely to occur. Assume that a collision accident between the first vehicle and the second vehicle occurs in this situation.

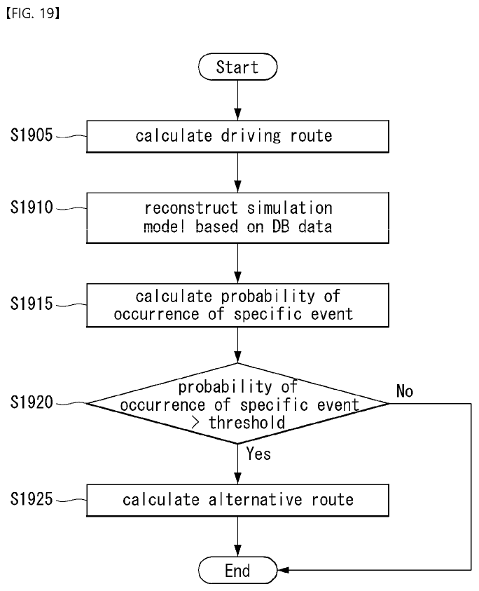

FIG. 18 is an example of a method for tracking an object related to a traffic accident in an autonomous driving system according to an embodiment of the present invention. FIG. 18 is merely for convenience of description and does not limit the scope of the present invention.

Referring to FIG. 18, it is assumed that the first vehicle is the vehicle 1810, the second vehicle is an object 2 1820, and the bicycle is the root cause object 1830. In addition, a plurality of objects (e.g., objects 1 to 5) may exist in multiple levels with respect to the root cause object.

For example, the server may track the object 2 1820 that caused a direct collision with vehicle 1810. In addition, the server may also track the root cause object 1830 that does not cause a direct collision with the vehicle 1810, but may affect the movement of the object 2 1820.

That is, through learning or rule-based determination, the server and/or vehicle (e.g., first vehicle) will not only monitor movement of the object 2 1820 (e.g., second vehicle), but also monitor the movement of the root cause object 1830 (e.g. bicycles). When the vehicle is placed in the situation, the server and/or the vehicle may configure a driving strategy such as slowing down or changing lanes to prevent an accident with the object 2 1820.

In addition, with respect to the simulation model as described above, the update of the application through the variable application of the scenario parameters may be additionally performed. After improving the application by reproducing the situation for a specific event (e.g., a collision event), it may be necessary to check whether other side effects occur due to the change of the application.

For example, weather information (i.e., weather parameters) may be variably applied to the simulation model. If a traffic accident occurred in sunny weather, the modified application may have been tuned to the brake control logic, etc. to match the dry road conditions in sunny weather. Therefore, when the traffic accident occurs on a snowy day, the control logic or the like may need to be modified more conservatively (or more robustly) in consideration of the friction coefficient of the icy road condition.

As another example, the driving route may be variably applied to the simulation model. Assume that a vehicle (i.e., a vehicle that is the subject of a traffic accident) is driving in the same lane as a bicycle and a vehicle following the bicycle. That is, while the bicycle, the following vehicle, and the vehicle are driving in the same lane, the vehicle may not perceive the bicycle due to the following vehicle in front. In this case, when the vehicle attempts to change the rapid lane to the side of the following vehicle in the front, a collision with the bicycle may occur according to the bicycle perception and control reaction speed of the vehicle.

In addition, when the above-described simulation model is generated, it may be necessary to reconstruct the simulation model according to the driving route of the vehicle. For example, the driving route set for the vehicle may be different from a traffic accident, a time zone, a traffic situation, a weather, etc. occurred previously. Therefore, it may be necessary to check whether the updated autonomous driving application based on the simulation model that reproduces the traffic accident may operate normally even in a new driving route of the vehicle.

FIG. 19 is an example of a reconstruction method of a simulation model according to a driving route of a vehicle in an autonomous driving system according to an embodiment of the present invention. FIG. 19 is merely for convenience of description and does not limit the scope of the present invention.

Referring to FIG. 19, it is assumed that the autonomous driving application of the vehicle is updated based on the above-described scheme, and additional driving is set for the vehicle.

The server may calculate a driving route of the vehicle (S1905). For example, the server may receive information on the driving route (and/or the destination) acquired through the user input from the vehicle or the like. Based on the received information, the server may calculate an expected driving route of the vehicle.

The server may reconstruct the simulation model using a database (DB)-based data (S1910). For example, a traffic pattern DB that accumulates and manages traffic conditions for each of weather, day of week, and time of day in the past may exist in a server. In this case, the server may reconstruct a previously generated simulation model using the traffic pattern DB. As another example, a weather information DB that manages weather information corresponding to the estimated time of passing through a major point in the travel route may exist in a server or the like. In this case, the server may reconstruct a previously generated simulation model using the weather information DB. As another example, an accident occurrence area DB for collecting and storing information on past traffic accidents may exist in a server or the like. In this case, the server may reconstruct a previously generated simulation model using the accident occurrence area DB. The server may be configured to check whether there is an area matching the route to be driven according to the accident type, and then input the corresponding information into the simulation model.

The server may calculate a probability of occurrence of a specific event (i.e., a collision event) based on the reconstructed simulation model (S1915). For example, the server may drive the estimated path of the vehicle by simulation based on the input of the DB described above, and calculate a probability of occurrence of traffic accident.

If the probability of occurrence of a specific event is not greater than a preset or predetermined threshold, the server may perform the reconstructed simulation based operation.

In contrast, when the probability of occurrence of a specific event is greater than a preset or predetermined threshold, the server may calculate an alternative route instead of the expected route (S1925). For example, when it is predicted that a traffic accident will occur in the expected route to be applied to the vehicle, the server may calculate an alternative route to be applied to the vehicle instead of the expected route. Thereafter, the server may transmit the information on the alternative route to the vehicle, through which a traffic accident of the vehicle may be prevented.

An example of the operation described in FIG. 19 may be as follows. As a user searches the route of the vehicle after work on Friday, the traffic pattern of the bicycle may be calculated as high for some zones of the route when referring to the traffic pattern DB, and the accident occurrence rate caused by the bicycle may also be calculated as high when referring to the accident occurrence DB. In this case, the autonomous vehicle may be set to present the user with an alternative route to avoid the corresponding zone.

Hereinafter, embodiments for methods of the present invention will be described.

Embodiment 1: in a method for updating an application for autonomous driving of a vehicle in an automated vehicle and highway systems, the method may comprise the steps of acquiring at least one of i) sensor data, ii) processing data, iii) database (DB)-based data, or iv) external data associated with a specific event; generating a simulation model for the occurrence of the specific event based on the acquired data, tracking at least one object associated with the specific event based on the simulation model; updating an application for the autonomous driving based on a tracking result of the at least one object, and transmitting the information on the updated application to the vehicle.

Embodiment 2: In the embodiment 1, the specific event may be a collision event between the vehicle and another object.

Embodiment 3: In the embodiment 2, the processing data may be acquired by performing a processing operation for the autonomous driving on the sensor data, and the DB-based data may include at least one of geographic information, traffic information, or autonomous driving infrastructure information determined based on location information of the vehicle.

Embodiment 4: In the embodiment 2, the external data may include information on a surrounding environment or information on the at least one object when the collision event occurs.

Embodiment 5: In the embodiment 2, the simulation model may be generated based on the occurrence of the collision event designed based on the acquired data and/or a control operation of the vehicle to reproduce the occurrence of the collision event.

Embodiment 6: In the embodiment 5, the simulation model may operate based on an application installed in the vehicle when the collision event occurs.

Embodiment 7: In the embodiment 2, the step of tracking the at least one object associated with the specific event may comprise the step of tracking objects in the order of high relevance, in consideration of relevance to the specific event.

Embodiment 8: In the embodiment 7, a first object that collided with the vehicle may be assigned in a high priority of the relevance, and a second object associated only with the first object may be assigned in a low priority of the relevance.

Embodiment 9: In the embodiment 8, the method may further comprise the step of tracking the objects in the order of high relevance, thereby identifying information of the object that causes the collision event.

Embodiment 10: In the embodiment 9, the method may further comprise the step of monitoring one or more objects determined using the information of the object that causes the collision event based on the updated application.

Embodiment 11: In the embodiment 2, the method may further comprise the step of receiving information on a scheduled route of the vehicle from the vehicle; and reconfiguring the updated application based on the information on the scheduled route of the vehicle.

Embodiment 12: In the embodiment 11, the information on the scheduled route of the vehicle may include at least one of i) traffic pattern information associated with the scheduled route, ii) weather information associated with the scheduled route, or iii) collision event information associated with the scheduled route.

Embodiment 13: In the embodiment 12, the method may further comprise the steps of calculating a probability of occurrence of a collision event on the scheduled route, by using the reconfigured application and information on the scheduled route of the vehicle; determining an alternative route for the vehicle, when the calculated probability of occurrence of the collision event value exceeds a preset threshold value; and transmitting the information on the determined alternative route to the vehicle.

Embodiment 14: In a server for updating an application for autonomous driving of a vehicle in an automated vehicle and highway systems, the server comprising: a processor for controlling a function of the server; a transceiver coupled to the processor and configured to transmit and/or receive data for controlling the vehicle; and a memory coupled to the processor and configured to store data for controlling the vehicle, wherein the processor configured to control: acquiring at least one of i) sensor data, ii) processing data, iii) database (DB)-based data, or iv) external data associated with a specific event; generating a simulation model for the occurrence of the specific event based on the acquired data; tracking at least one object associated with the specific event based on the simulation model; updating an application for the autonomous driving based on a tracking result of the at least one object; and transmitting the information on the updated application to the vehicle.

Embodiment 15: In the embodiment 14, the specific event may be a collision event between the vehicle and another object.

Embodiment 16: In the embodiment 15, the processing data may be acquired by performing a processing operation for the autonomous driving on the sensor data, and the DB-based data may include at least one of geographic information, traffic information, or autonomous driving infrastructure information determined based on location information of the vehicle.

Embodiment 17: In the embodiment 15, the external data may include information on a surrounding environment and/or information on the at least one object when the collision event occurs.

Embodiment 18: In the embodiment 15, the simulation model may be generated based on the occurrence of the collision event designed based on the acquired data and a control operation of the vehicle to reproduce the occurrence of the collision event.

Embodiment 19: In the embodiment 18, the simulation model may operate based on an application installed in the vehicle when the collision event occurs.

Embodiment 20: In the embodiment 15, the processor may be further configured to control tracking objects in the order of high relevance, in consideration of relevance to the specific event, associated with tracking the at least one object associated with the specific event.

Embodiment 21: In the embodiment 20, a first object that collided with the vehicle may be assigned in a high priority of the relevance, and a second object associated only with the first object may be assigned in a low priority of the relevance.

Embodiment 22: In the embodiment 21, the processor may be further configured to track the objects in the order of high relevance to control identifying information of the object that causes the collision event.

Embodiment 23: In the embodiment 22, the processor may be further configured to control monitoring one or more objects determined using the information of the object that causes the collision event based on the updated application.

Embodiment 24: In the embodiment 22, the processor may be further configured to: control receiving information on a scheduled route of the vehicle from the vehicle; and control reconfiguring the updated application based on the information on the scheduled route of the vehicle.

Embodiment 25: In the embodiment 24, the information on the scheduled route of the vehicle may include at least one of i) traffic pattern information associated with the scheduled route, ii) weather information associated with the scheduled route, or iii) collision event information associated with the scheduled route.

Embodiment 26: In the embodiment 25, the processor may be further configured to: control calculating a probability of occurrence of a collision event on the scheduled route, by using the reconfigured application and information on the scheduled route of the vehicle; control determining an alternative route for the vehicle, when the calculated probability of occurrence of the collision event value exceeds a preset threshold value; and control transmitting the information on the determined alternative route to the vehicle.

The above-described present invention can be implemented with computer-readable code in a computer-readable medium in which program has been recorded. The computer-readable medium may include all kinds of recording device capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present invention without departing from the spirit or scope of the invention described in the appended claims. For example, each component described in detail in embodiments can be modified. In addition, differences related to such modifications and applications should be interpreted as being included in the scope of the present invention defined by the appended claims.

Although description has been made focusing on examples in which the present invention is applied to automated vehicle & highway systems based on 5G (5 generation) system, the present invention is also applicable to various wireless communication systems and autonomous devices.

What is claimed is:

1. A method for updating an application for autonomous driving of a vehicle in an automated vehicle and highway systems, the method comprising:
acquiring at least one of i) sensor data, ii) processing data, iii) database (DB)-based data, or iv) external data associated with a specific event;
generating a simulation model for the occurrence of the specific event based on the acquired data;
tracking at least one object associated with the specific event based on the simulation model;
updating an application for the autonomous driving based on a tracking result of the at least one object; and
transmitting, to the vehicle, the information on the updated application.

2. The method of claim 1, wherein the specific event is a collision event between the vehicle and another object.

3. The method of claim 2, wherein the processing data is acquired by performing a processing operation for the autonomous driving on the sensor data, and
wherein the DB-based data includes at least one of geographic information, traffic information, or autonomous driving infrastructure information determined based on location information of the vehicle.

4. The method of claim 2, wherein the external data includes information on a surrounding environment or information on the at least one object when the collision event occurs.

5. The method of claim 2, wherein the simulation model is generated based on the occurrence of the collision event designed based on the acquired data and a control operation of the vehicle to reproduce the occurrence of the collision event.

6. The method of claim 5, wherein the simulation model operates based on an application installed in the vehicle when the collision event occurs.

7. The method of claim 2, wherein the step of tracking the at least one object associated with the specific event comprises the step of:
tracking objects in the order of high relevance, in consideration of relevance to the specific event.

8. The method of claim 7, wherein a first object that collided with the vehicle is assigned in a high priority of the relevance, and
a second object associated only with the first object is assigned in a low priority of the relevance.

9. The method of claim 8, further comprising tracking the objects in the order of high relevance, thereby identifying information of the object that causes the collision event.

10. The method of claim 9, further comprising monitoring one or more objects determined using the information of the object that causes the collision event based on the updated application.

11. The method of claim 2, further comprising the steps of:
receiving information on a scheduled route of the vehicle from the vehicle; and
reconfiguring the updated application based on the information on the scheduled route of the vehicle.

12. The method of claim 11, wherein the information on the scheduled route of the vehicle includes at least one of i) traffic pattern information associated with the scheduled route, ii) weather information associated with the scheduled route, or iii) collision event information associated with the scheduled route.

13. The method of claim 12, further comprising the steps of:
calculating a probability of occurrence of a collision event on the scheduled route, by using the reconfigured application and information on the scheduled route of the vehicle;
determining an alternative route for the vehicle, when the calculated probability of occurrence of the collision event value exceeds a preset threshold value; and
transmitting the information on the determined alternative route to the vehicle.

14. A server for updating an application for autonomous driving of a vehicle in an automated vehicle and highway systems, comprising:
a processor for controlling a function of the server;
a transceiver coupled to the processor and configured to transmit and/or receive data for controlling the vehicle; and
a memory coupled to the processor and configured to store data for controlling the vehicle,
wherein the processor further configured to control:
acquiring at least one of i) sensor data, ii) processing data, iii) database (DB)-based data, or iv) external data associated with a specific event;
generating a simulation model for the occurrence of the specific event based on the acquired data;
tracking at least one object associated with the specific event based on the simulation model;
updating an application for the autonomous driving based on a tracking result of the at least one object; and
transmitting, to the vehicle, the information on the updated application.

15. The server of claim 14, wherein the specific event is a collision event between the vehicle and another object.

16. The server of claim 15, wherein the processing data is acquired by performing a processing operation for the autonomous driving on the sensor data, and
wherein the DB-based data includes at least one of geographic information, traffic information, or autonomous driving infrastructure information determined based on location information of the vehicle.

17. The server of claim 15, wherein the external data includes information on a surrounding environment or information on the at least one object when the collision event occurs.

18. The server of claim 15, wherein the simulation model is generated based on the occurrence of the collision event designed based on the acquired data and a control operation of the vehicle to reproduce the occurrence of the collision event.

19. The server of claim 18, wherein the simulation model operates based on an application installed in the vehicle when the collision event occurs.

20. The server of claim 15, wherein the processor is further configured to control tracking objects in the order of high relevance, in consideration of relevance to the specific event, associated with tracking the at least one object associated with the specific event.

21. The server of claim 20, wherein a first object that collided with the vehicle is assigned in a high priority of the relevance, and
a second object associated only with the first object is assigned in a low priority of the relevance.

22. The server of claim 21, wherein the processor is further configured to track the objects in the order of high relevance to control identifying information of the object that causes the collision event.

23. The server of claim 22, wherein the processor is further configured to control monitoring one or more objects determined using the information of the object that causes the collision event based on the updated application.

24. The server of claim 15, wherein the processor is further configured to:
control receiving information on a scheduled route of the vehicle from the vehicle; and
control reconfiguring the updated application based on the information on the scheduled route of the vehicle.

25. The server of claim 24, wherein the information on the scheduled route of the vehicle includes at least one of i) traffic pattern information associated with the scheduled route, ii) weather information associated with the scheduled route, or iii) collision event information associated with the scheduled route.

26. The server of claim 25, wherein the processor is further configured to:
control calculating a probability of occurrence of a collision event on the scheduled route, by using the reconfigured application and information on the scheduled route of the vehicle;
control determining an alternative route for the vehicle, when the calculated probability of occurrence of the collision event value exceeds a preset threshold value; and
control transmitting the information on the determined alternative route to the vehicle.
